(19) United States
(12) Patent Application Publication
(10) Pub. No.: US 2009/0299699 A1
(43) Pub. Date: Dec. 3, 2009

(54) AUDIO TESTING SYSTEM AND METHOD

(75) Inventor: DAN-FENG WU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) Co., LTD., Shenzhen City (CN); HON HAI PRECISION INDUSTRY CO., LTD., Tu-Cheng (TW)

(21) Appl. No.: 12/333,643

(22) Filed: Dec. 12, 2008

(30) Foreign Application Priority Data
May 30, 2008 (CN) 200810301874.5

(51) Int. Cl. G06F 15/00

(52) U.S. Cl. 702/186

(57) ABSTRACT

An audio testing system includes a computer and a mobile terminal. The computer includes a first audio recording and storing module, and a testing module. A first audio file is stored in the computer. The mobile terminal includes a second audio recording and storing module, and a second playing module. The testing module starts up the second recording and storing module to record and store the first audio file as a second audio file, starts up the second audio playing module to play the second audio file, and starts up the first audio recording and storing module to record and store the second audio file as a third audio file in the computer. The computer compares a waveform of the third audio file with a waveform of the first audio file to determine if an audio of the mobile terminal meets a standard.

### BACKGROUND

1. Technical Field

The present disclosure relates to an audio testing system and a method for a mobile terminal.

2. Description of Related Art

Mobile terminals such as mobile phones are becoming increasingly popular. The mobile terminal is tested to validate functions of the mobile terminal before being shipped.

Although audio testing of the mobile phone is important, it is typically tested through direct listening. It is up to a tester's judgment if the audio is sufficient. This method of testing is time consuming and subject to human error.

What is needed, therefore, is an audio testing system and an audio testing method, which allows automatic testing of a mobile terminal.

### BRIEF DESCRIPTION OF THE DRAWINGS

FIG. 1 is a block diagram of an embodiment of an audio testing system; and

FIG. 2 is a flow chart of an embodiment of an audio testing method.

### DETAILED DESCRIPTION

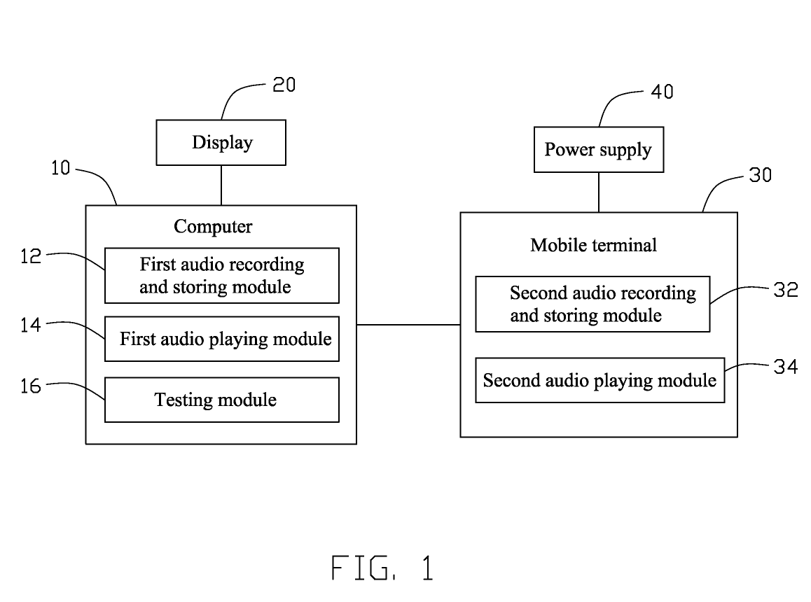

Referring to FIG. 1, an embodiment of an audio testing system includes a computer 10, a display 20 connected to the computer 10, a mobile terminal 30 connected to the computer 10 through a serial port of the computer 10, and a power supply 40 connected to the mobile terminal 30.

The computer 10 includes a first audio recording and storing module 12, a first audio playing module 14, and a testing module 16. The mobile terminal 30 includes a second audio recording and storing module 32 and a second audio playing module 34.

The first audio recording and storing module 12 records an audio file and stores the audio file in the computer 10. The first audio playing module 14 plays the audio file stored in the computer 10. The second audio recording and storing module 32 records an audio file and stores the audio file in the mobile terminal 30. The second audio playing module 34 plays the audio file stored in the mobile terminal 30. The testing module 16 starts up the first audio playing module 14 to play the audio file stored in the computer 10, starts up the second audio recording and storing module 32 to record and store the audio file played by the first audio playing module 14 in the mobile terminal 30, starts up the second audio playing module 34 to play the audio file, and starts up the first audio recording and storing module 12 to record and store the audio file played by the second audio playing module 34 in the computer 10.

The computer 10 compares waveforms of the audio file recorded by the first recording and storing module 12 to waveforms of the audio file played by the first audio playing module 14, and determines if the error between the waveforms falls within a pre-determined range stored in the computer 10. If the error is within the pre-determined range, the mobile terminal 30 has passed the audio testing. Otherwise, the mobile terminal 30 has failed.

The display 20 displays the testing process and test results. The power supply 40 supplies the working voltage to the mobile terminal 30.

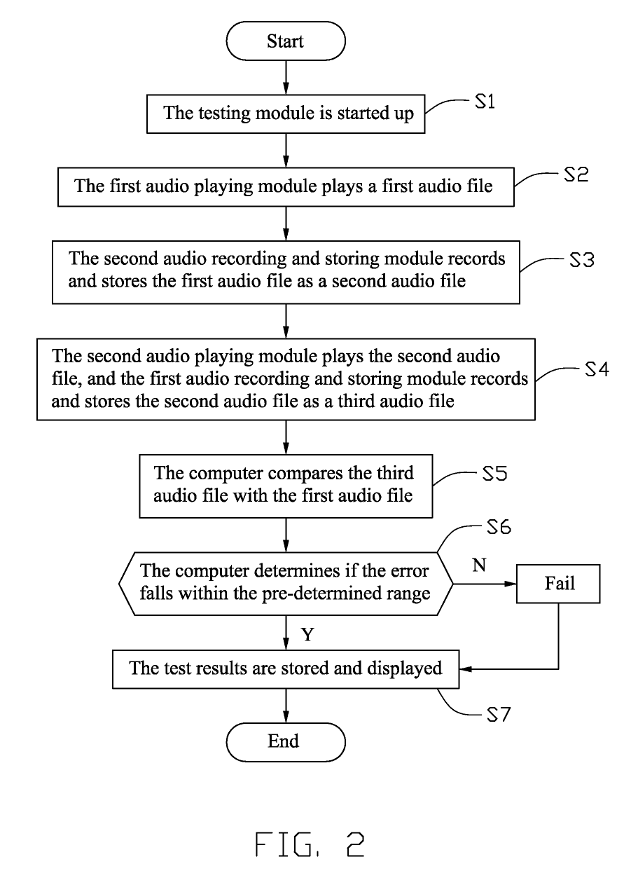

Referring to FIG. 2, a flow chart of an audio testing method is shown. Depending on the embodiment, certain of the steps described below may be removed, others may be added, and the sequence of steps may be altered.
S1: The testing module 16 of the computer 10 is started up;
S2: The first audio playing module 14 of the computer 10 plays a first audio file stored in the computer 10;
S3: The second audio recording and storing module 32 of the mobile terminal 30 records the first audio file and stores the first audio file as a second audio file in the mobile terminal 30;
S4: The second audio playing module 34 of the mobile terminal 30 plays the second audio file; the first audio recording and storing module 12 of the computer 10 records the second audio file played by the second audio playing module 34 and stores the second audio file as a third audio file in the computer 10;
S5: The computer 10 compares the third audio file with the first audio file;
S6: The computer 10 determines if the error between the waveforms of the third audio file and the first audio file falls within the pre-determined range stored in the computer 10; if the error is within the pre-determined range, the mobile terminal 30 passes the audio testing; otherwise, the mobile terminal 30 fails the audio testing;
S7: The test results are stored in the computer 10, and displayed on the display 20.

In other embodiments, the mobile terminal 30 can record the first audio file and store it as a second audio file by other methods, so that the first audio file need not be played as described in step S2 above, and can be copied directly by the mobile terminal 30.

It is to be understood, however, that even though numerous characteristics and advantages of the embodiments have been set forth in the foregoing description, together with details of the structure and function of the disclosure, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. An audio testing system, comprising:
a computer comprising a first audio recording and storing module, and a testing module, wherein a first audio file is stored in the computer; and
a mobile terminal connected to the computer, the mobile terminal comprising a second audio recording and storing module, and a second audio playing module;
wherein the testing module starts up the second recording and storing module to record and store the first audio file as a second audio file, starts up the second audio playing module to play the second audio file, and starts up the first audio recording and storing module to record and store the second audio file as a third audio file in the computer; the computer compares a waveform of the third audio file with a waveform of the first audio file to determine if an audio function of the mobile terminal meets a standard.

2. The audio testing system of claim 1, wherein the computer further comprises a first playing module; the testing module also starts up the first playing module to play the first audio file for the second recording and storing module records, and stores the first audio file as the second audio file.

3. The audio testing system of claim 1, further comprising a display to display testing processes and test results.

4. The audio testing system of claim 1, further comprising a power supply connected to the mobile terminal to supply the working voltage to the mobile terminal.

5. The audio testing system of claim 1, wherein the mobile terminal is connected to the computer through a serial port of the computer.

6. An audio testing method, comprising:
providing a computer;
recording a first audio file stored in the computer as a second audio file by a mobile terminal, and playing the second audio file;
recording the second audio file as a third audio file by the computer;
comparing a waveform of the third audio file with a waveform of the first audio file; and
determining if an audio of the mobile terminal meets a standard.

7. The audio testing method of claim 6, further comprising playing the first audio file by the computer for recording the first audio file as the second audio file by the mobile terminal.

8. The audio testing method of claim 7, wherein the computer comprises a first audio playing module to play the first audio file, and a first audio recording and storing module to record the second audio file as the third audio file.

9. The audio testing method of claim 6, wherein if the error between two waveforms of the third audio file and the first audio file falls within a pre-determined range stored in the computer, audio testing of the mobile terminal passes.

10. The audio testing method of claim 9, wherein if the error does not fall within the pre-determined range, audio testing of the mobile terminal fails.

11. The audio testing method of claim 6, wherein the mobile terminal comprises a second recording and storing module to record the first audio file as the second audio file, and a second audio playing file to play the second audio file.

12. The audio testing method of claim 6, further comprising displaying the testing process and the test results on a display.
